(19) United States
(12) Patent Application Publication
(10) Pub. No.: US 2016/0082482 A1
(43) Pub. Date: Mar. 24, 2016

(54) DEVICE FOR CLEANING ROLLERS IN A ROLLER ASSEMBLY

(71) Applicant: MICRONOVA MANUFACTURING, INC., Torrance, CA (US)

(72) Inventors: Phillip LeCompte, Anaheim, CA (US); Robert Emmons, West Bridgewater, MA (US)

(73) Assignee: Micronova Manufacturing, Inc., Torrance, CA (US)

(21) Appl. No.: 14/785,315

(22) PCT Filed: Apr. 30, 2014
(86) PCT No.: PCT/US2014/036129

§ 371 Date: Oct. 16, 2015

Related U.S. Application Data
(60) Provisional application No. 61/817,856, filed on Apr. 30, 2013.

(51) Int. Cl. B08B 1/00

(52) U.S. Cl. CPC B08B 1/008

(57) ABSTRACT

Apparatus and methods for cleaning rollers include a cleaning device having a longitudinally extending frame forming a channel with a profile that conforms in part to a roller to be cleaned.

### BACKGROUND

### Field

These inventions relate to roller cleaning devices, for example cleaning devices for rollers used in incubators, including rollers used in roller incubators, or for example cleaning devices for transportation and conveyor devices, for example cleaning rollers used in material conveyors and conveyor systems.

### SUMMARY

In one example of a cleaning device for rollers, the device can include a longitudinally extending frame, for example having a configuration of a channel having a substantially semi-cylindrical profile. The channel is used to clean a surface of a cylindrical roller. In one configuration, the profile defines a semi circle, and in another configuration the profile defines a shape having a cross-section extending greater than a half-circle. In any of the foregoing configurations, the cleaning device can be used to clean a substantial area of the surface of a roller.

In another example of a cleaning device for rollers, the device can include at least one longitudinally-extending channel that can include a cross-sectional profile having a curvature conforming to part of a circle, in one example a semi circle, and in another example the cross-sectional profile has a portion defining part of a circle, and first and second longitudinally extending walls extending away from the portion defining part of the circle. In one configuration, the first and second longitudinally extending walls are spaced apart from and extend substantially parallel to each other. In another example, they are non-parallel relative to each other, for example as they extend outwardly from the portion defining part of the circle.

In a further example of a cleaning device for rollers, the device can include two or more longitudinally extending cleaning pad supports wherein the supports have a profile that approximates or is complementary to a roller surface to be cleaned. In the example of two cleaning pad supports or at least one pair of cleaning pad supports, each of the cleaning pad supports in a pair are oriented with respect to each other to face in substantially opposite directions, with one in the pair being substantially a mirror image of the other about a longitudinally-extending plane between the two of them. In examples of more than two cleaning pad supports, the cleaning pad supports can be arranged symmetrically or as desired to achieve the desired result of ease of use and/or cleaning, and with even numbers, they can be arranged in pairs, wherein the cleaning pad supports in each pair are positioned so as to face in opposite directions relative to each other. In an example of four cleaning pad supports, each may extend longitudinally. A first cleaning pad support in a first pair faces opposite a second cleaning pad support in the first pair, and in the same direction as and parallel to a first cleaning pad support in the second pair. The second cleaning pad support in the first pair extends in the same direction as and parallel to a second cleaning pad support in the second pair. The spacing between the first cleaning pad supports in the first and second pairs is selected so as to be substantially the same as the spacing between adjacent rollers to be cleaned by them. In an example of roller incubators, for example, the spacing between adjacent rollers at a given horizontal level is well defined and known. In an example of a roller incubator having a plurality of spaced apart rows of longitudinally extending and parallel rollers, rollers closest to each other in adjacent rows are positioned so as to be at their closest spacing possible. In this configuration, first cleaning pad supports in first and second pairs can be used to clean their respective rollers simultaneously, and likewise with second cleaning pad supports in the first and second pairs.

In an additional example of a cleaning device for rollers, the device can include at least one longitudinal-extending channel having an at least partly circular profile terminating in substantially straight sidewalls extending parallel to each other from the at least partly circular profile. Where the at least partly circular profile defines a semi circle, the substantially straight sidewalls extend beyond to form a profile in cross-section of greater than 180°. Where the cleaning device includes more than one channel, each channel can include the same profile configuration.

In a further example of a cleaning device for rollers, the device can include at least one longitudinally-extending channel where the longitudinal extent of the channel can cover a longitudinal length of the roller to be cleaned. In one example, the length of the channel relative to the overall length of the roller surface to be cleaned may be between 5% and 15%, and for example between 5% and 10%. In one example, the channel length relative to the roller length is approximately 7%.

In another example of a cleaning device for rollers, the device can include at least two longitudinally-extending channels opening away from each other, and wherein the base or bottom of one channel is spaced apart laterally from the base or bottom of the other channel. They are generally mirror images of each other about a plane between them with a line intersecting the bottom of a channel normal thereto also being normal to the plane. The channels can be supported in fixed positions relative to each other by one or more brackets or other support structures so that they can be reliably moved along corresponding roller surfaces for cleaning as desired. In one example, the two channels are supported so that they extend longitudinally substantially parallel to each other facing in substantially opposite directions. In another example, they extend so that they are not parallel to each other relative to a plane extending between them. In one example, a mounting bracket for adjacent channels can be configured to receive a handle so that the handle can be used to position and manipulate the cleaning device.

In an example of a method for using a cleaning device for rollers, for example rollers in a roller incubator, a cleaning channel for supporting a cleaning pad has a cleaning pad positioned thereon. The cleaning device is manipulated so as to place the cleaning pad against the roller to be cleaned. The cleaning device is pushed distally on a forward stroke, for example parallel to an axis of the roller, so as to clean an adjacent surface of the roller. Where the cleaning device has only a single channel and pad, the cleaning device can be lifted and moved horizontally to the next adjacent or any other desired roller, or can be pivoted 180° to clean the surface of a roller in an adjacent row by placing the channel and pad against the roller and moving the cleaning device proximally in a backstroke. Where the cleaning device has a pair of channels and respective pads (or multiple pairs), facing in opposite directions, the cleaning device is manipulated so as to place a first cleaning pad against the roller to be cleaned and pushed distally in a forward stroke to clean the surface of the roller. The cleaning device is then lifted without rotating to place the second cleaning pad against a roller (upward, for example) in an adjacent row of rollers whose surface is then cleaned on a backstroke. Where the cleaning device has a pair of channels and respective pads extending laterally adjacent and parallel to each other, and facing the same direction, the adjacent pads can be used to clean simultaneously corresponding surfaces on adjacent rollers in the same row. In any of the examples described herein, a roller surface can be cleaned by way of a forward stroke and a backstroke.

These and other examples are set forth more fully below in conjunction with drawings, a brief description of which follows.

### BRIEF DESCRIPTION OF THE DRAWINGS

FIG. 1 is an upper right isometric view of a cleaning device and handle without cleaning pads illustrated in one example of the present inventions.

FIG. 2 is a side elevation view of the cleaning device of FIG. 1 without the handle.

FIG. 3 is a right side elevation view of the assembly of FIG. 1.

FIG. 4 is an upper isometric view of a nut for a coupler assembly for use in securing an adapter to the cleaning device.

FIG. 5 is an upper isometric view of a coupler pin for nut of FIG. 4.

FIG. 6 is a schematic and upper right isometric view of the cleaning device of FIG. 1 and a pair of rollers in adjacent rows of rollers to be cleaned.

FIG. 7 is a schematic and end elevation view of the schematic of FIG. 6.

FIG. 8 is a schematic and upper right isometric view similar to that of FIG. 6.

FIG. 9A is a side elevation view of the cleaning device of FIG. 2.

FIG. 9B is a bottom plan view of a pad for use with a channel on the cleaning device of FIG. 9A.

FIG. 9C is a top plan view of a pad for use with a channel on the cleaning device of FIG. 9A.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of tools and of methods of making and using the tools are described. Depending on what feature or features are incorporated in a given structure or a given method, benefits can be achieved in the structure or the method. For example, tools using a pair of cleaning elements may achieve better results than with a single element.

These and other benefits will become more apparent with consideration of the description of the examples herein. However, it should be understood that not all of the benefits or features discussed with respect to a particular example must be incorporated into a tool, component or method in order to achieve one or more benefits contemplated by these examples. Additionally, it should be understood that features of the examples can be incorporated into a tool, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of tool configurations and of methods of making and using the tools are described herein, and some have particular benefits in being used together. Additionally, it will be understood that a given component or method could be combined with other structures or methods not expressly discussed herein while still achieving desirable results.

Incubator rollers are used as examples of applications for a tool that can incorporate one or more of the features and derive some of the benefits described herein. However, other applications for the present tool configurations other than incubator rollers can benefit from one or more of the present inventions.

It should be understood that terminology used for orientation, such as front, rear, side, left and right, upper and lower, and the like, are used herein merely for ease of understanding and reference, and are not used as exclusive terms for the structures being described and illustrated.

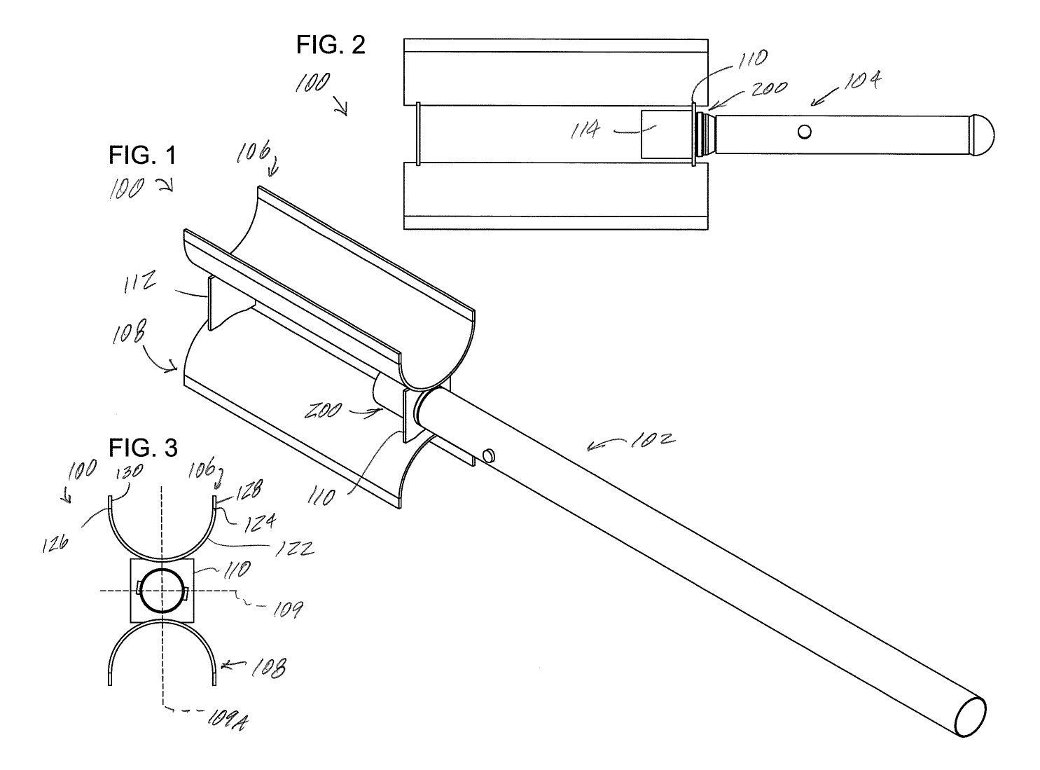

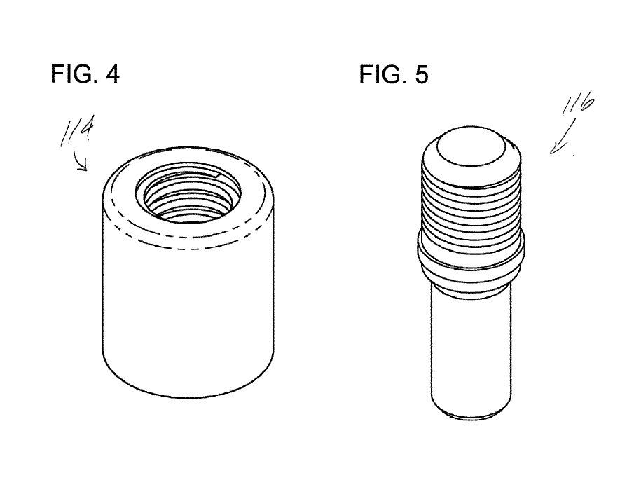

A device for cleaning rollers includes a cleaning device 100 (FIGS. 1-3 and 6-9C). The cleaning device 100 can be supported on and manipulated by a handle 102 (FIG. 1) coupled to the cleaning device 100 by way of a coupling assembly 200 (FIGS. 1-2 and 4-5). The cleaning device can be supported on the handle 102 through a quick-disconnect adapter 104. Use of the quick-disconnect adapter allows the cleaning device 100 to be used with quick-disconnect handles, such as the SSU series handles provided by Micronova Manufacturing Inc. The components of the handle, adapter and cleaning device can be formed from electro polished 304 stainless steel, and Delrin for the coupler assembly, or other materials. For example, the coupling assembly 200 can be formed from polypropylene impregnated with talc. The materials can be selected so as to be compatible with clean room environments.

The cleaning device 100 includes at least one, and in the present examples, two longitudinally extending frames having configurations in the form of channels 106 and 108. As shown in FIGS. 1-2, each of the channel frames 106 and 108 extends longitudinally substantially parallel to a central axis of the handle 102. In this configuration, a user can know that when the handle is horizontal, for example, or otherwise aligned with a reference axis, then the channels 106 and 108 in the longitudinal dimension would also be horizontal or aligned with the reference axis. Therefore, proximal or distal movement of the assembly with the handle horizontal or aligned with the reference axis will indicate that the channels 106 and 108 are also horizontal or aligned with the reference axis.

In the example illustrated, the channel frames 106 and 108 are secured together in a spaced apart relationship and facing in opposite directions by proximal and distal brackets 110 and 112, respectively. The brackets are configured and positioned so that the pair of channels extend longitudinally substantially parallel to each other with a substantially constant spacing between them over the length of the channels. They are generally mirror images of each other about a plane 109 between them with a line 109A intersecting the bottom of a channel normal thereto also being normal to the plane. Each of the two channels have the same length, transverse cross-sectional profile and dimensions. They are also formed from the same material, in the present example 304 electro polished stainless steel. The channels may be welded or braised to the brackets. The illustrated brackets are metal plates.

The proximal bracket 110 includes an opening for receiving the coupler assembly 200, which sandwiches the proximal bracket 110 between the components of the coupler assembly 200. The coupler assembly includes a nut 114 having an internally threaded bore. The coupler assembly 200 also includes an externally threaded pin 116, which extends through an opening in the proximal bracket 110 and threads into and engages the internally-threaded nut 114. The pin 116 includes an outer cylindrical surface that extends into an internal bore in the adapter 104, and may be secured into the interior of the adapter by press fit and fixed with a roll pin. When the nut 114 and the pin 116 are threaded together with the proximal bracket 110 in between, the coupling assembly 200 can be used to mount the cleaning device 100 on the adapter 104. Other mounting arrangements for the cleaning device 100 can be used.

In the illustrated configuration, the longitudinally extending channel frames are substantially identical, but they can be different if desired. As described herein, each of the channel frames are identical, but positioned and/or oriented differently. In the present example, the first and second channels 106 and 108 are substantially identical but face in opposite directions. While a single channel can be used on the cleaning device, and a pair of channels is presently illustrated, an additional pair or pairs of channels can also be incorporated into the cleaning device, for example supported symmetrically with respect to the adapter 104. However, only one of the channels 106 will be described further.

In the illustrated configuration, the frame defining the channel 106 is substantially semi-cylindrical, and has an end or cross-sectional profile (FIG. 3) having a substantially semi-circular portion 122 extending from a first point 124 approximately 180° to a second point 126. The channel 106 has the same profile over the entire length of the channel. Each end of the semicircular portion 122 terminates in a substantially straight portion 128 and 130, each extending substantially parallel to a tangent to the semicircular portion 122. In this configuration, the profile of the channel defines a shape having a cross section greater than a half circle. The straight portions 128 and 130 extend outward from the semicircular portion 122 substantially parallel to each other, and extend longitudinally the entire length of the channel. They can also be non-parallel to each other, for example flared or diverging with respect to each other, or converging with respect to each other. The straight portions 128 and 130 help to provide adequate cleaning of a cylindrical roller, and also help to maintain alignment of the cleaning device on the roller, for example in stationary or when moving distally or proximally.

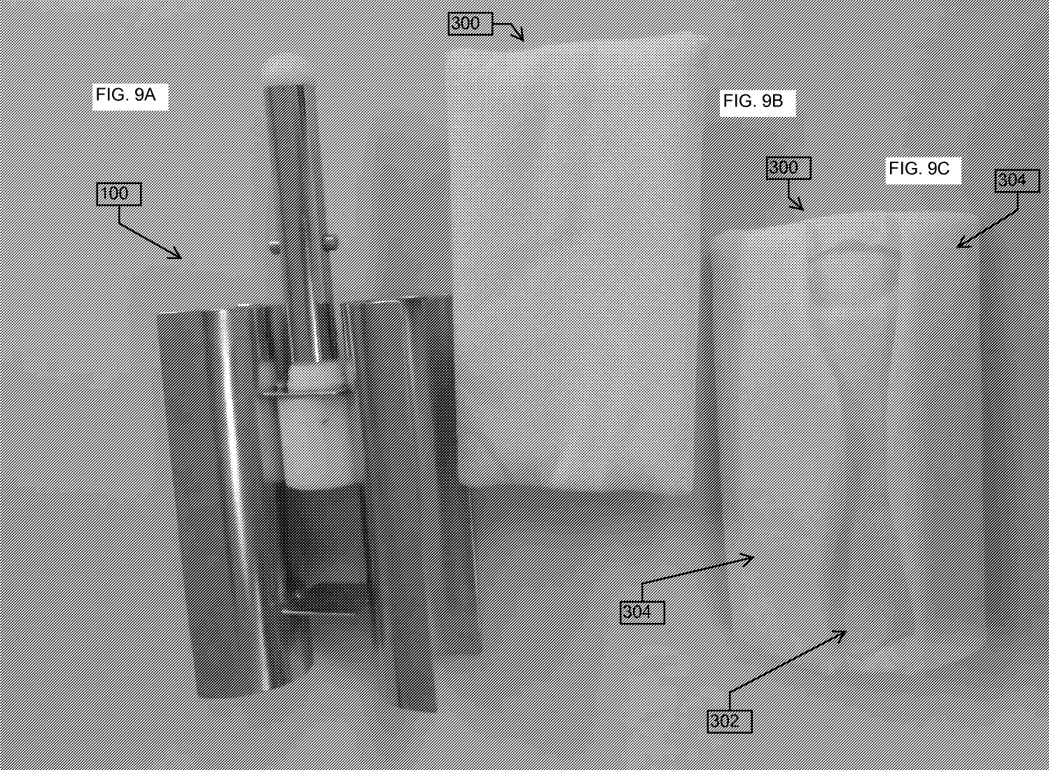

In the present illustrated example, the semi-circular portion 122 is constructed to have a diameter of 2 inches. The depth of the channel from the bottom to the rim of the channel is 1.25 inches. Consequently, the substantially straight portions 128 and 134 are 0.25 inches each in width, extending from the ends of a semi-circular portion. The first and second channels 106 and 108 are separated by the brackets a distance of 1.25 inch.

Where the cleaning device is intended to be used with a known equipment configuration, such as a roller incubator having a known configuration, the longitudinal length of the channels 106 and 108 can be selected so as to improve usable cleaning surface area of the pads (FIGS. 9B and 9C). The length of the channel relative to the overall length of the roller surface to be cleaned can be selected so as to be greater than or equal to 5% of the roller surface length to be cleaned. In the present configuration, the channel length relative to the overall roller surface length to be cleaned is between 5% and 15%, and more specifically between five and 10%. In a present example, the channel length relative to the roller length is approximately 7%.

The cleaning device 100 will include a cleaning pad 300 (FIGS. 9B and 9C) supported by respective channels. Each cleaning pad 300 includes a foam or other filler, which may be absorbent, and a cleaning fabric or material cover. The bottom of the cleaning pad may have a substantially uniform surface (FIG. 9B) for contacting and cleaning the roller, while the top of the cleaning pad has a center opening 302 into side slots or pouches 304 formed by stitching a layer or layers of fabric or material along three perimeter sides of the cleaning pad. A pad is then placed over a respective channel, and conforms to the shape of the channel.

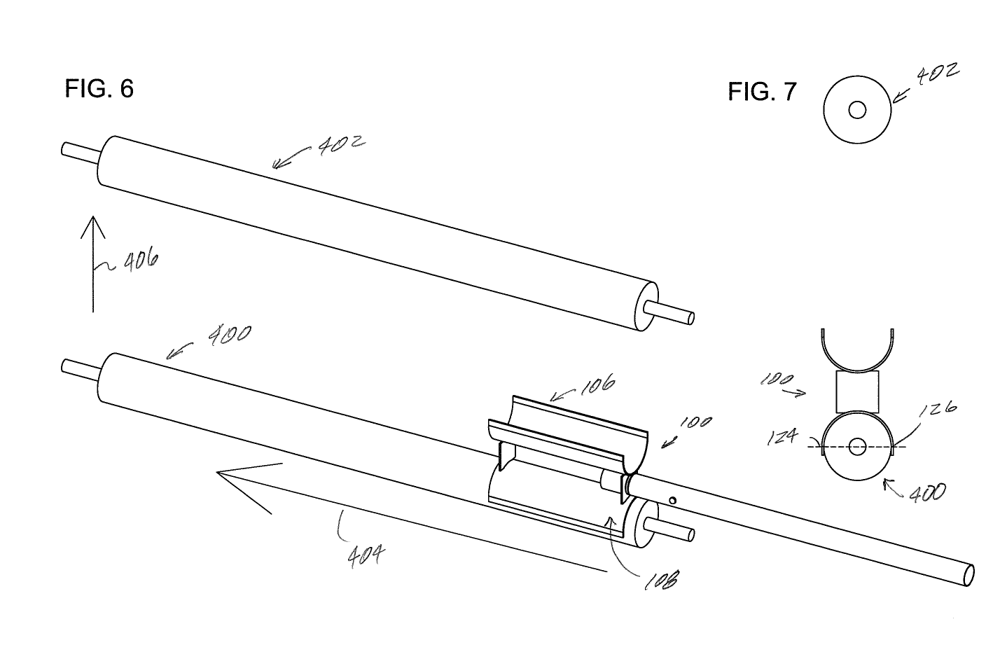

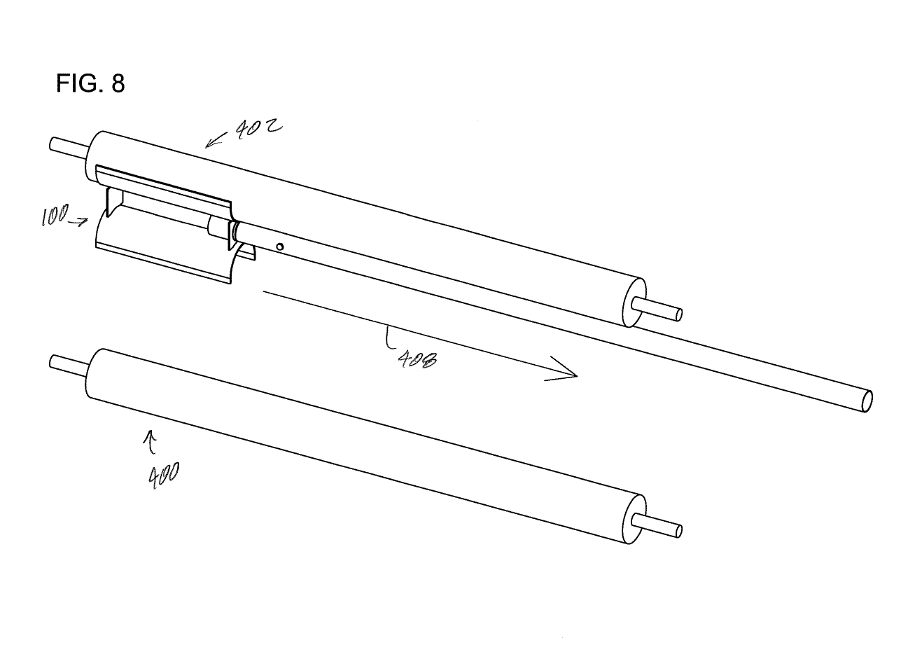

To clean a roller, such as rollers 400 and 402 (FIGS. 6-8), the cleaning element channel 108 and its pad are placed over the upper surface of the roller 400. The user manipulates the handle to push the cleaning device 100 in a forward stroke in the direction of the arrow 404 so as to clean the adjacent surface of the roller, keeping the handle parallel to the central axis of the roller 400. At the end of the forward stroke, the user lifts the cleaning assembly in the direction of the arrow 406 without pivoting or rotating until the cleaning element channel 106 and its cleaning pad contact the roller 402. The user then manipulates the handle to move the cleaning device in a backward stroke in the direction of the arrow 408 (FIG. 8) keeping the handle parallel to the central axis of the roller 402. The cleaning device can then be separated from the roller 402 and translated to a next pair of rollers.

Where the cleaning device has only a single channel and pad, the cleaning device can be translated or moved in the forward stroke 404 to the distal end of the roller 400. The cleaning device can then be lifted from the roller 400, pivoted 180° and the channel and its pad placed against the roller 402. The assembly is then retracted on a backstroke to clean the roller 402.

Where the cleaning device has two parallel channels and respective pads extending laterally adjacent each other and parallel and facing in the same direction, with a lateral spacing corresponding to a lateral spacing of adjacent pairs of rollers (not shown), adjacent rollers in one row of rollers can be cleaned on a single forward stroke, followed by cleaning of an adjacent pair of rollers in the same row on a backstroke.

While the channels can be formed from stainless steel, it is also possible to form the channels from injection molded plastic. The channel can then have incorporated in it or molded thereto or secured thereto a foam backing to be covered by a suitable cleaning fabric or material. The channel can be solid, as illustrated in the present configurations, perforated, a skeleton structure or other configuration sufficient to support a cleaning material or surface against a roller surface. Other configurations are also possible.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

1. A cleaning apparatus comprising a support structure, a handle attachment secured to the support structure for securing a handle to the support structure, and a frame supported by the support structure wherein the frame is configured to support a cleaning material having a cleaning surface, and wherein the frame extends longitudinally of the support structure and has a partly-circular profile.

2. The apparatus of claim 1 wherein the frame has a partly cylindrical profile.

3. The apparatus of claim 1 wherein the frame has a cross-sectional profile extending greater than a half circle.

4. The apparatus of claim 1 wherein the partly circular profile frame includes first and second edge surfaces extending longitudinally and first and second substantially straight extension walls extending from the circular profile frame to respective ones of the first and second edge surfaces.

5. The apparatus of claim 4 wherein the straight extension walls extend parallel to each other.

6. The apparatus of claim 4 wherein the straight extension walls diverge from each other.

7. The apparatus of claim 4 wherein the straight extension walls converge toward each other.

8. The apparatus of claim 1 wherein the support structure supports the frame spaced from an axis of the handle attachment.

9. The apparatus of claim 8 wherein the support structure supports the frame so that the frame extends longitudinally parallel to a central axis of the handle attachment.

10. The apparatus of claim 8 wherein the handle attachment is positioned on the support structure substantially laterally centered.

11. The apparatus of claim 1 wherein the support structure supports a first frame and a second frame.

12. The apparatus of claim 11 wherein the first and second frames extend parallel to each other in a longitudinal direction.

13. The apparatus of claim 11 wherein the first and second frames face in opposite directions.

14. The apparatus of claim 11 wherein the first and second frames have identical profiles.

15. The apparatus of claim 11 wherein the first and second frames are spaced substantially equidistant from a central axis through the handle attachment.

16. The apparatus of claim 1 further including a cleaning material extending on the frame.

17. The apparatus of claim 1 further including a handle engaging the handle attachment.

18. The apparatus of claim 1 wherein the frame is positioned adjacent a roller having a length, and wherein the frame extends a first distance longitudinally between approximately 5 and 10% of the roller length.

19. A cleaning apparatus for rollers comprising a support structure having first and second end portions, a handle attachment secured to the first end portion of the support structure, a first semicircular frame secured to the support structure and extending longitudinally and spaced laterally from the handle attachment, and a second semicircular frame secured to the support structure opposite the first semicircular frame, and extending longitudinally and spaced laterally from the handle attachment.

20. The apparatus of claim 19 wherein the first and second frames have identical profiles.

21. The apparatus of claim 19 wherein the first and second frames extend parallel to each other.

22. The apparatus of claim 19 wherein each of the first and second frames have respective straight sidewall portions at respective ends of a half circle portions.

23. A method of cleaning a roller comprising placing a longitudinally extending partially cylindrical frame having a cleaning surface thereon in contact with a roller surface, and translating the frame and cleaning surface along a surface of the roller.

24. The method of claim 23 further including moving the frame from the roller to a second roller and translating the frame along a surface of the second roller.

25. The method of claim 24 wherein translating the frame and cleaning surface along a surface of the first roller includes translating the frame in a first direction, and wherein translating the frame along the surface of the second roller is in a direction opposite the first direction.

26. The method of claim 23 further including placing a second frame in contact with a second roller surface adjacent the first roller surface and translating the second frame along the surface of the second roller at the same time of translating the first frame along the surface of the first roller.

27. The method of claim 23 wherein translating the frame includes translating the frame using a handle attached to a support structure supporting the frame.
